(19) United States
(12) Patent Application Publication
(10) Pub. No.: US 2006/0010775 A1
(43) Pub. Date: Jan. 19, 2006

(54) Tuned window sash

(76) Inventors: Dongling Tao, Canton, MI (US); John W. Whitehead, Dearborn, MI (US); Len A. Wolf, Ann Arbor, MI (US)

Correspondence Address: Frost Brown Todd LLC, 201 East Fifth Street, Suite 2200, Cincinnati, OH, 45202, US

(21) Appl. No.: 10/892,650

(22) Filed: Jul. 16, 2004

(51) Int. Cl. B60J 1/16

(52) U.S. Cl. 49/375

(57) ABSTRACT

A window sash reduces noise through a window pane. The window sash includes a bracket with a tuned mass damper. The window sash can be tuned by adjusting the interval spacing of attachment points or cut-out areas. The spaced intervals may be equal to a multiple of the wavelength of the frequency targeted for noise reduction. The frequency targeted for noise reduction may be the coincidence frequency of the window pane. The stiffness and/or mass of the window sash, the bracket, and/or the stiffeners coupled to the bracket can also be tuned.

### BACKGROUND OF THE INVENTION

There are many aspects to noise control. Noise control may involve the use of a variety of materials and techniques. Specific frequencies or frequency ranges may be selectively targeted for noise reduction. The present invention pertains to a window sash that can be tuned. More particularly, the invention pertains to a window sash, comprising a bracket, that can be tuned to reduce noise transmitted through a window pane at a specific frequency.

### BRIEF DESCRIPTION OF THE DRAWING

FIG. 1 depicts a window sash attached to a vehicle window pane wherein a window regulator is attached to the window sash.

FIG. 2 depicts a window sash attached to a vehicle window pane wherein a window sash is separate from a window regulator.

FIG. 3 depicts an isometric view of a bracket of a window sash having a stiffener with side attachment points.

FIG. 4 depicts an isometric view of a bracket of a window sash having a stiffener with center attachment points.

FIG. 5 depicts an isometric view of a bracket of a window sash having a stiffener.

FIG. 6 depicts an isometric view of a bracket of a window sash having separated pieces of rubber liner.

FIG. 7 depicts an isometric view of a bracket of a window sash having a stiffener.

FIG. 7a depicts a cross-sectional view of a window sash.

FIG. 8 depicts an isometric view of a bracket of a window sash having a stiffener.

FIG. 9 depicts an isometric view of a bracket of a window sash having a stiffener.

FIG. 10 depicts an isometric view of a bracket of a window sash having a stiffener.

FIG. 10a depicts a cross-sectional view of a bracket of a window sash having a stiffener.

FIG. 11 depicts an isometric view of a bracket of a window sash having cut-out sections.

FIG. 12 depicts an isometric view of a bracket of a window sash having cut-out sections.

FIG. 12a depicts a view of a cut-out section of the window sash of FIG. 12.

FIG. 13 depicts an isometric view of a bracket of a window sash having cut-out sections.

FIG. 13a depicts a cross-sectional view of a window sash of FIG. 13.

FIG. 14 depicts an isometric view of a bracket of a window sash having cut-out sections.

FIG. 15 depicts an isometric view of a bracket of a window sash having a non-uniform cross-section.

FIG. 16 depicts an isometric view of a bracket of a window sash having a non-uniform cross-section.

FIG. 17 depicts an isometric view of a bracket of a window sash having a non-uniform cross-section.

FIG. 18 depicts an isometric view of a bracket of a window sash coupled to a window pane.

FIG. 18a depicts a cross-sectional view of a window sash of FIG. 18.

FIG. 19 depicts an isometric view of a bracket of a window sash coupled to a window pane.

FIG. 20 depicts a side view of a window sash with a stiffener.

FIG. 20a depicts a cross-sectional view of a window sash of FIG. 20.

FIG. 21 is a graph depicting the noise transmission loss improvement resulting from a window sash of the present invention.

### DETAILED DESCRIPTION OF THE INVENTION

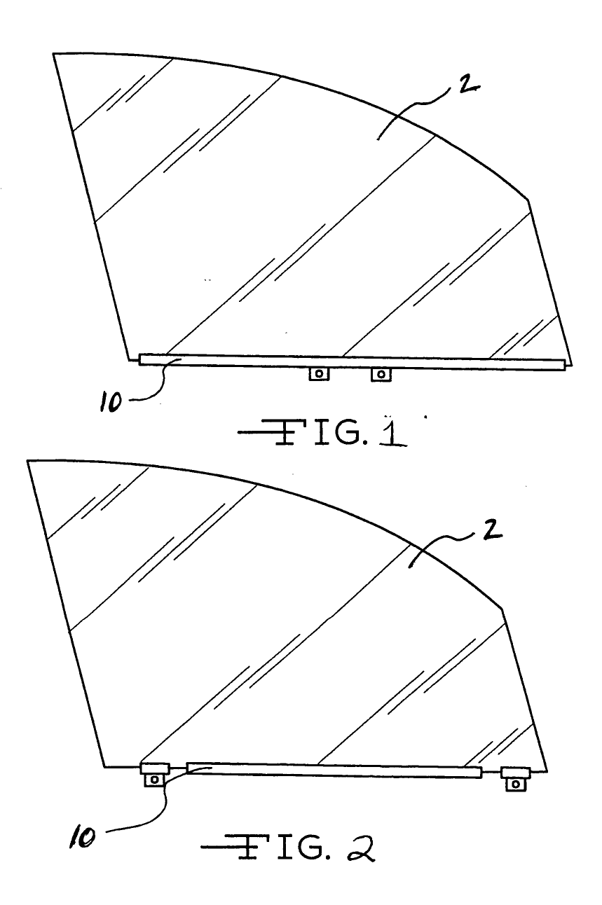

Window sashes are well known in the art. Window sashes are used for mounting one or more window panes to another structure. For example, window sashes may be used to mount windows into vehicle doors. Window sashes typically have a bracket with a U-shaped, or similar, cross-section for receiving an edge portion of a window pane. The window sash 10 may be of a configuration capable of mounting a window pane 2 to a window regulating mechanism, as shown in FIG. 1. The window sash may also be comprised of one or more window sash portions disposed along the length of a window pane. When used in a vehicle, the window sash may be attached to a bottom edge of a window pane and may or may not be attached to a window regulating mechanism that causes the window to open and to close. See FIGS. 1 and 2.

Referring now to the window sash of the present invention, the window sash comprises a bracket that can be tuned, i.e., a tunable bracket. It may further comprise a stiffener that can be tuned, i.e., a tunable stiffener. As used in this disclosure, “tuning” or “tuned” means adjusting the interval spacing of the window sash; the stiffness of the bracket, stiffener, and/or window sash; the mass of the bracket, stiffener, and/or window sash; or any combination of the interval spacing, the stiffness of the bracket, stiffener, and/or window sash, and the mass of the bracket, stiffener, and/or window sash for the purpose of reducing noise through a window pane and often, but not necessarily, for the purpose of reducing noise through the window pane at a targeted frequency. The targeted frequency may be the coincidence frequency of the window pane. The coincidence frequency of a window pane is the frequency where the glass naturally allows more noise to pass through.

The coincidence frequency of a panel, f_{c}, may be calculated as follows:

$${f}_{c} = \frac{{c}^{2}}{π t} \sqrt{\frac{3 ρ ( 1 - {υ}^{2} )}{E}}$$

Where c is the speed of sound in air, t is the thickness of the panel, ρ is the density of the panel material, v is the Poisson's ratio of the panel material, and E is the Young's modulus of the panel material.

The flexural wavelength, λ, of a panel at its coincidence frequency may be calculated as follows:

$$λ = \sqrt[4]{\frac{{π}^{2} {Et}^{2}}{3 ρ {f}_{c}^{2} ( 1 - {v}^{2} )}}$$

Where E is the Young's modulus of the panel material, t is the thickness of the panel, ρ is the density of the panel material, f_{c} is the coincidence frequency of the panel, and v is the Poisson's ratio of the panel material.

For use in the present invention, the coincidence frequency can be determined using the above described formulas for the window pane, the window sash, the bracket or the stiffener.

The bracket of the present invention may be any configuration capable of mounting a window pane in a desired structure. The bracket may have any one of a variety of cross-sections, including U-shaped, V-shaped, L-shaped, C-shaped, and the like. The bracket may be tuned by adjusting its stiffness and/or mass, for example by selecting a particular cross-sectional shape, including bracket thickness. The bracket may also have any of a variety of profiles on its inner surfaces. Some examples of the variation possible among bracket cross-sections and the inner surfaces of the bracket are provided in the various figures included herewith. Additionally, the bracket's cross-section, thickness, and inner surface profile may vary along its length.

The bracket can also be tuned by choosing a material of a particular rigidity and/or density. The bracket may be comprised of any sufficiently rigid material, including metal, such as steel or aluminum; plastic, such as polyvinyl chloride (PVC), nylon, ultra-high molecular weight polyethylene (UHMW), or other rigid plastics; composite materials, such as fiberglass or carbon fiber/epoxy; combinations thereof; and the like. The bracket may be manufactured using any methods known in the art, including but not limited to, molding, extruding, casting, stamping, forming, and machining.

The bracket may further comprise a window pane-receiving sleeve, which fits between the window pane and the inner surface of the bracket. Such sleeves are well-known in the art. They are typically made of a rubber or elastomeric material. The sleeve may be made of any materials known in the art for use as a window pane-receiving sleeve. The inner surface of the sleeve, which contacts the glass surface, comprises the inner surface of the bracket.

The window sash may further comprise a stiffener coupled to the bracket. The stiffener may have one or more suitable cross-sections, including, but not limited to, rectangular, square, circular, semi-circular, triangular, trapezoidal, or u-shaped cross-sections. The stiffener may be substantially solid, substantially hollow, or some combination thereof. The stiffener may be made of any sufficiently rigid material, including metal, such as steel or aluminum; plastic, such as polyvinyl chloride, nylon, ultra-high molecular weight polyethylene, or other rigid plastics; composite materials, such as fiberglass or carbon fiber/epoxy; combinations thereof, and the like. The stiffener may be manufactured using any of a variety of manufacturing processes such as molding, extruding, casting, machining, forming, stamping, or the like. The stiffener can be tuned by choosing a material of a particular stiffness and/or density. The stiffener may also be tuned by adjusting its stiffness and/or mass by selecting a particular thickness, cross-section, or construction. The stiffener may or may not be comprised of the same material as the bracket.

The window sash may be tuned by coupling the stiffener to the bracket at spaced intervals. The window sash may likewise be tuned by removing material from the bracket at spaced intervals. In either instance, the interval spacing can be chosen to tune the bracket to a specific frequency. The spaced intervals along the bracket may each be equal in length. Moreover, the spaced intervals may be equal to a multiple of the wavelength (e.g., half the wavelength, 1× the wavelength, 2× the wavelength) of the frequency of noise through the window pane targeted for reduction. The spaced intervals may be equal to a multiple of the wavelength of the coincidence frequency of the window pane.

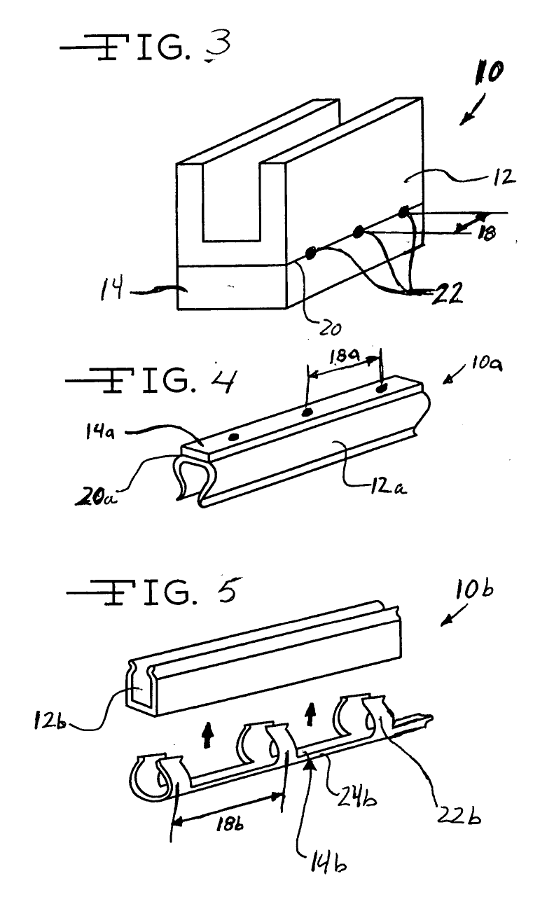

In one embodiment of the invention, the window sash 10 is comprised of a bracket 12 and stiffener 14 as shown in FIG. 3-6. The stiffener 14 is comprised of one or more bars that are manufactured, in part or in whole, separately from the bracket 12. The stiffener 14 is then coupled to the bracket 12 by techniques known in the art including, but not limited to, tack welds, spot welds, ultrasonic welds, rivets, bolts, screws, clips, adhesives or any manner suitable for coupling similar or dissimilar materials.

As shown in FIG. 3, the window sash 10 comprises a bracket 12 with a stiffener 14 comprising a single rectangular bar coupled to a lower edge portion 20 of bracket 12 at side attachment points 22, located at the outer edge of the bottom of the bracket 12 and the stiffener 14. The stiffener 14 can be substantially solid, substantially hollow, or some combination thereof. The stiffener 14 may extend substantially the length of the bracket 12, which may extend substantially the length of a window pane. The stiffener 14 may be separated into several smaller sections positioned along the length of the bracket. The stiffener 14 may or may not be comprised of the same material as the bracket 12.

The stiffener 14 may be coupled to the lower edge portion 20 of the bracket 12 at spaced intervals 18 by tack welds, spot welds, ultrasonic welds, rivets, bolts, screws, clips, adhesives or any manner suitable for coupling similar or dissimilar materials. The spaced intervals 18 can be chosen so as to tune the window sash 10. The spaced intervals 18 may each be equal in length. Moreover, the spaced intervals 18 may be equal to a multiple of the wavelength of the frequency of noise through the window pane targeted for reduction. The spaced intervals 18 may be equal to the wavelength of the coincidence frequency of the window pane.

The window sash 10 may also be tuned by adjusting the material or configuration of the stiffener 14, the material or configuration of the bracket 12, and/or the method of attachment of the stiffener 14 to the bracket 12. In addition, the window sash 10 may be tuned by any combination of adjusting the attachment intervals 18; selecting the method of attaching the stiffener 14 to the bracket 12; selecting the material or configuration of the stiffener 14; and/or selecting the material or configuration of the bracket 12.

In another embodiment of the invention, the window sash 10a comprises a bracket 12a and a stiffener 14a, as shown in FIG. 4. The stiffener 14a comprises a single bar coupled to bracket 12a at central points along the stiffener 14a. The stiffener 14a has a rectangular cross-section. The stiffener 14a may be substantially solid, substantially hollow, or some combination thereof. The stiffener 14a may extend substantially the length of the bracket, which may extend substantially the length of the window pane. The stiffener 14a may be separated into several smaller sections positioned along the length of the bracket 12a. The stiffener 14a may or may not be comprised of the same material as the bracket 12a.

The stiffener 14a may be coupled to the central region of the lower edge portion 20a of the bracket 12a at spaced intervals 18a by tack welds, spot welds, ultrasonic welds, rivets, bolts, screws, clips, adhesives or any manner suitable for coupling similar or dissimilar materials. The spaced intervals 18a can be chosen so as to tune the window sash 10a. The spaced intervals 18a may each be equal in length. Moreover, the spaced intervals 18a may be equal to a multiple of the wavelength of the frequency of noise through the window pane targeted for reduction. The spaced intervals 18a may be equal to the wavelength of the coincidence frequency of the window pane.

The window sash 10a may also be tuned by adjusting the material or configuration of the stiffener 14a, the material or configuration of the bracket 12a, and/or the method of attachment of the stiffener 14a to the bracket 12a. The window sash 10a may also be tuned by any combination of adjusting the attachment intervals 18a; selecting the method of attaching the stiffener 14a to the bracket 12a; selecting the material or configuration of the stiffener 14a; and/or selecting the material or configuration of the bracket 12a.

In another embodiment of the invention, the window sash 10b comprises a bracket 12b and one or more stiffeners 14b, as shown in FIG. 5. The stiffener 14b comprises a bar section 24b with one or more fingers 22b that extend from the bar section 24b. The stiffener 14b may extend substantially the length of the bracket 12b, which may extend substantially the length of the window pane. The stiffener 14b may be separated into several smaller sections positioned along the length of the bracket 12b. The stiffener 14b may or may not be comprised of the same material as the bracket 12b.

The fingers 22b couple the stiffener 14b to the bracket 12b at spaced intervals 18b. The spaced intervals 18b can be chosen so as to tune the window sash 10b. The spaced intervals 18b may each be equal in length. Moreover, the spaced intervals 18b may be equal to a multiple of the wavelength of the frequency of noise through the window pane targeted for reduction. The spaced intervals 18b may be equal to the wavelength of the coincidence frequency of the window pane.

The fingers 22b may be spring clips that clamp around the bracket 12b. Alternatively, the fingers 22b may be attached to the bracket by means of tack welds, spot welds, ultrasonic welds, rivets, bolts, screws, clips, adhesives, or any manner suitable for coupling similar or dissimilar materials. One or more stiffeners 14b may be coupled to bracket 12b. The stiffener 14b may extend substantially the length of the window pane, or it may extend only a portion of length of the window pane. The length of stiffener 14b may be coextensive with the length of bracket 12b, or one or more shorter stiffeners 14b may be used in conjunction with a longer bracket 12b.

The window sash 10b may also be tuned by adjusting the material or configuration of the stiffener 14b, the material of the bracket 12b, and the method of attachment of the stiffener 14b to the bracket 12b, e.g., spring clips may be less stiff than multiple spot welds. The window sash 10b may also be tuned by any combination of adjusting the attachment intervals 18b; selecting the method of attaching the stiffener 14b to the bracket 12b; selecting the configuration or material of the stiffener 14b; and/or selecting the material of the bracket 12b.

In another embodiment of the invention, the window sash 10c comprises a bracket 12c and stiffener 14c, as shown in FIG. 6. The stiffener 14c comprises at least two inserts 26c configured to fit within the inside portion 28c of the bracket 12c.

The at least two inserts 26c may be placed within the inside portion 28c of the bracket 12c at spaced intervals 18c. The spaced intervals 18c may be chosen to tune the window sash 10c. The spaced intervals 18c may each be equal in length. Moreover, the spaced intervals 18c may be equal to a multiple of the wavelength of the frequency of noise through the window pane targeted for reduction and may be equal to the wavelength of the coincidence frequency of the window pane.

The length of the at least two inserts 26c may extend substantially all or some portion of the length of bracket 12c, which itself may extend all or some portion of the length of the window pane. The inserts 26c may be spaced along substantially all or some portion of the length of the bracket 12c. They may or may not be comprised of the same material as the bracket 12c.

The window sash 10c may also be tuned by adjusting the material or configuration of the inserts 26, the material or configuration of the bracket 12c, and the method of attachment of the inserts 26 to the bracket 12c, e.g., the inserts 26 may be snapped into place within bracket 12c or they may be welded or bonded into place. The window sash 10c may also be tuned by any combination of adjusting the attachment intervals 18c; selecting the method of attaching the inserts 26 to the bracket 12c; selecting the number, length and configuration of the inserts 26; selecting the material or configuration of the inserts 26; and/or selecting the material or configuration of the bracket 12c.

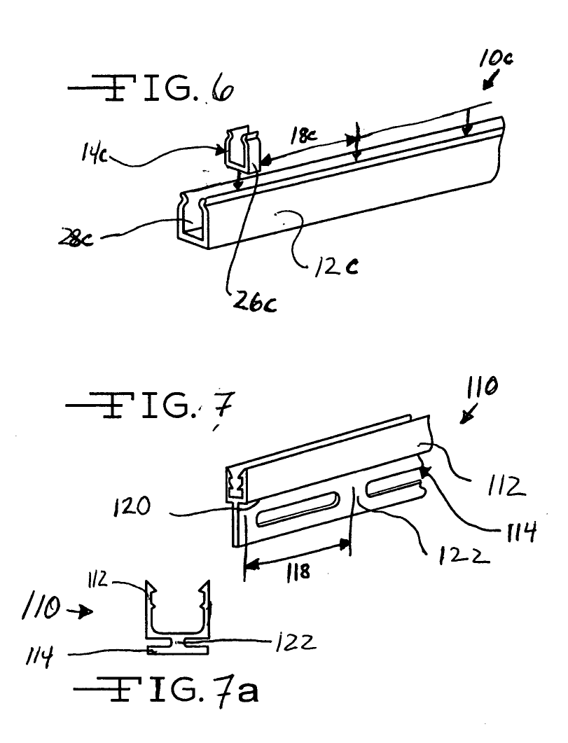

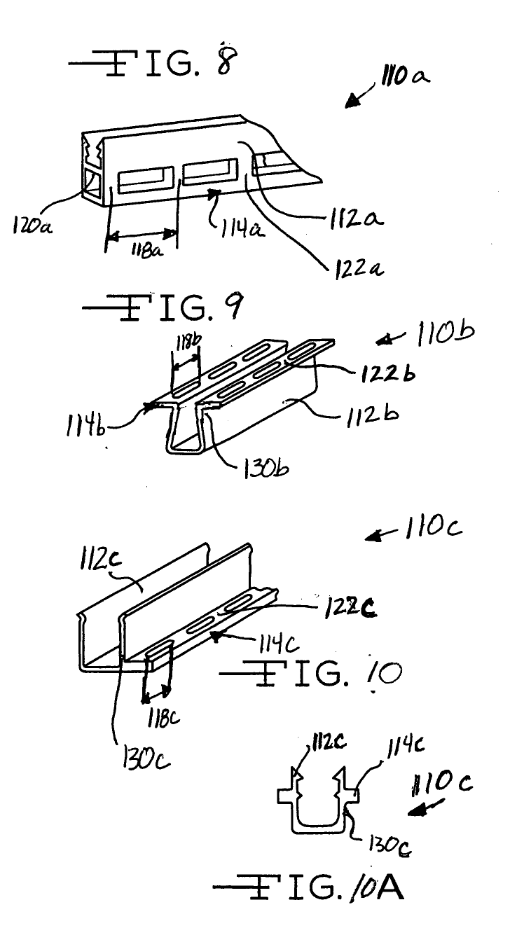

In another embodiment of the invention, the window sash 110, 110a comprises a bracket 112, 112a and one or more stiffeners 114, 114a as shown in FIG. 7-10. The window sash 110, 110a can be manufactured such that the bracket 112, 112a and one or more stiffeners 114, 114a are manufactured as a unitary piece. As shown in FIG. 7, 7a, and 8, the one or more stiffeners 114, 114a may comprise a bar extending from the bracket 112, 112a. One or more pillars 122, 122a extend from the underside 120, 120a of the bracket 112, 112a to the lower edge of the stiffener 114, 114a. The pillars 122, 122a couple the stiffener 114, 114a to the bracket 112, 112a at spaced intervals 118, 118a where the interval 118, 118a extends from centerline to centerline of pillar 122, 122a. The spaced intervals 118, 118a may be produced as part of an initial manufacturing process, such as a molding process, or may be produced in a subsequent operation by removal of material from the window sash 110, 110a, such as by machining or drilling.

The spaced intervals 118, 118a can be selected to tune the window sash 110, 110a. The spaced intervals 118, 118a may each be equal in length. Moreover, the spaced intervals 118, 118a may be equal to the wavelength of the frequency of noise through the window pane targeted for reduction and may be equal to the wavelength of the coincidence frequency of the window pane.

The stiffener(s) 114, 114a may or may not extend substantially the length of the bracket 112, 112a. The stiffener(s) 114, 114a may have any cross-section, including rectangular, square, circular, semi-circular, triangular, trapezoidal, u-shaped and the like. The stiffener(s) 114, 114a may be substantially solid (as shown in FIG. 7, 7a), substantially hollow (as shown in FIG. 8), or some combination thereof. The bracket 112, 112a and stiffener(s) 114, 114a can be manufactured as a unitary piece through a variety of manufacturing processes such as molding, extruding, casting, and the like.

The window sash 110, 110a may also be tuned by adjusting the stiffness and/or mass of the window sash, bracket, and/or stiffener by adjusting the material comprising bracket 112, 112a and stiffener(s) 114, 114a, and/or the configuration of the stiffener(s) 114, 114a and/or bracket 112, 112a. The window sash 110, 110a may also be tuned by any combination of adjusting the attachment intervals 118, 118a; selecting the configuration of the stiffener(s) 114, 114a and/or bracket 112, 112a; and/or selecting the material of the stiffener 114, 114a and bracket 112, 112a.

In another embodiment of the invention, the window sash 110b, 110c comprises a bracket 112b, 112c and one or more stiffeners 114b, 114c, as shown in FIG. 9, 10, and 10a. The window sash 110b, 110c is manufactured such that the bracket 112b, 112c and one or more stiffeners 114b, 114c are manufactured as a unitary piece. The one or more stiffeners 114b, 114c are coupled to one or more side portions 130b, 130c of the bracket 112b, 112c. One or more pillars 122b, 122c extend from the side portion(s) 130b, 130c of the bracket 112b, 112c to the outer edge of the stiffener 114b, 114c. The pillars 122b, 122c couple the stiffener 114b, 114c to the bracket 112b, 112c at spaced intervals 118b, 118c where the interval 118b, 118c extends from centerline to centerline of pillar 122b, 122c. The spaced intervals 118b, 118c may be produced as part of an initial manufacturing process, such as a molding process, or may be produced in a subsequent operation by removal of material, such as by machining or drilling.

The spaced intervals 118b, 118c can be selected to tune the window sash 112b, 112c. The spaced intervals 118b, 118c may each be equal in length. Moreover, the spaced intervals 118b, 118c may be equal to a multiple of the wavelength of the frequency of noise through the window pane targeted for reduction and may be equal to the wavelength of the coincidence frequency of the window pane.

The stiffener(s) 114b, 114c may or may not extend substantially the length of the bracket 112b, 112c. The stiffener(s) 114b, 114c may have any suitable cross-section, including rectangular, square, circular, semi-circular, triangular, trapezoidal, u-shaped and the like. The stiffener(s) 114b, 114c may be substantially solid, substantially hollow, or some combination thereof. The bracket 112b, 112c and stiffener(s) 114b, 114c are manufactured as a unitary piece through a variety of manufacturing processes such as molding, extruding, casting, forming, stamping, machining, and the like.

The window sash 110b, 110c may also be tuned by adjusting the stiffness and/or mass of the bracket and/or stiffener by adjusting the material comprising bracket 112b, 112c and stiffener(s) 114b, 114c, and/or the configuration of the stiffener(s) 114b, 114c and/or bracket 112b, 112c. The window sash may also be tuned by any combination of adjusting the attachment intervals 118b, 118c; selecting the configuration of the stiffener(s) 114b, 114c and/or bracket 112b, 112c; and/or selecting the material of the stiffener 114b, 114c and bracket 112b, 112c.

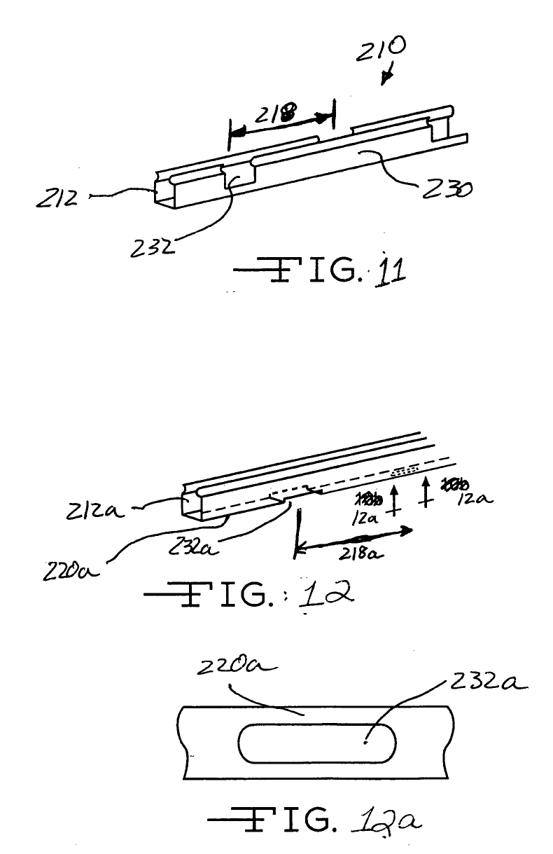

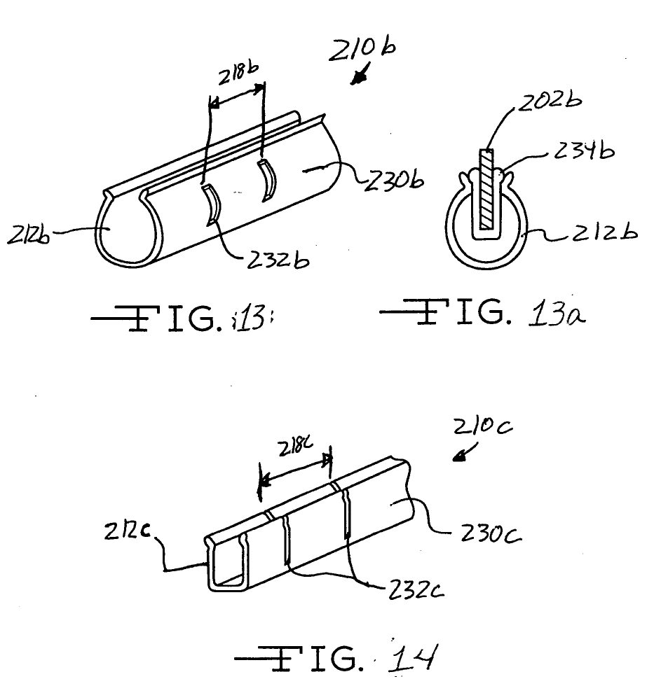

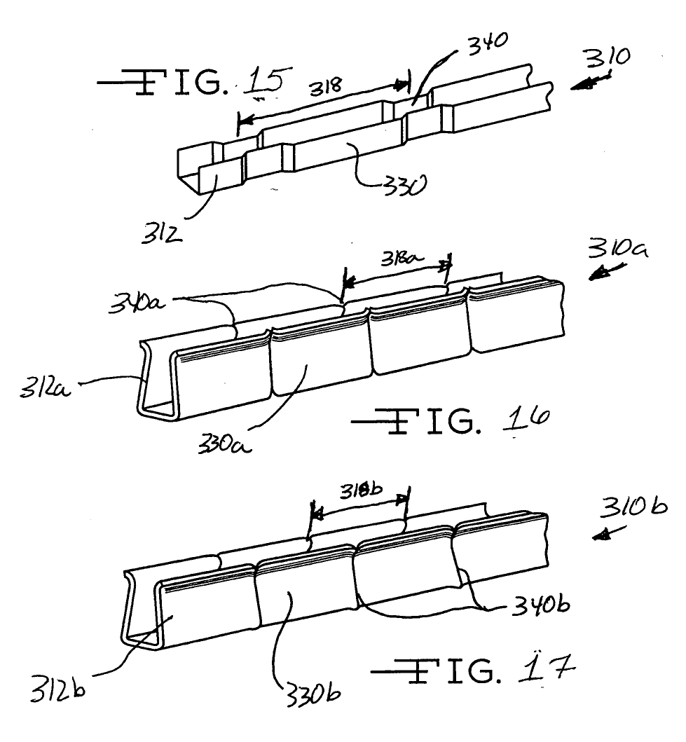

In other embodiments of the invention, as shown in FIG. 11-14, the window sash 210 may be tuned by removing one or more sections of material from the bracket 212. As shown in FIGS. 11, 12 and 14, one or more cut-out sections 232, 232a, 232c may be removed from one or more side portions 230, 230c (FIG. 11, 14) or bottom portions 220a (FIG. 11, 11b) of the bracket 212, 212a, 212c. The cut-out sections 232a, 232b may be closed, as shown in FIGS. 12 and 13; or they may be open, as shown in FIGS. 11 and 14. The cut-out sections 232, 232a, 232c in FIGS. 11, 12 and 14 may be of any shape, including rectangular, triangular, circular, oval, and the like. The bracket 212, 212a, 212c may be manufactured such that the cut-out section(s) 232, 232a, 232c are included in an initial manufacturing process, such as a molding process, or may be removed in a subsequent process, such as by subsequent machining.

The cut-out sections 232, 232a, 232c may be separated by spaced intervals 218, 218a, 218c. The spaced intervals 218, 218a, 218c can be selected to tune the window sash 210, 210a, 210c. The spaced intervals 218, 218a, 218c may each be equal in length. The spaced intervals 218, 218a, 218c may be equal to a multiple of the wavelength of the frequency of noise through the window pane targeted for reduction. They may be equal to the wavelength of the coincidence frequency of the window pane.

The number, size, shape, and spacing of the cut-out section(s) 232, 232a, 232c can be chosen and adjusted to tune the window sash 210, 210a, 210c. The bracket 212, 212a, 212c may also be tuned by adjusting its stiffness and/or mass by selection of the material from which it is made and/or the configuration, including thickness, of the bracket 212, 212a, 212c.

In an embodiment of the invention shown in FIG. 13, the window sash 210b comprises a bracket 212b with one or more cut-out sections 232b removed from one or more side portions 230b of the bracket 212b. An edge of window pane 202b is contained in one or more sleeves 234b. One or more sleeves 234b fits within bracket 212b. The one or more sleeves 234b may extend substantially the length of the bracket 212b, which may itself extend substantially the length of the window pane 202b. The cut-out sections 232b may be of any shape, including rectangular, triangular, circular, oval, and the like. The bracket 212b may be manufactured such that the cut-out section(s) 232b are included in an initial manufacturing process, such as a molding process, or may be removed in a subsequent process, such as by subsequent machining.

The cut-out sections 232b are separated by spaced intervals 218b. The window sash 210b can be tuned by selection of the spaced intervals 218b. The spaced intervals 218b may each be equal in length. The spaced intervals 218b may be equal to a multiple of the wavelength of the frequency of noise through the window pane targeted for reduction and may be equal to the wavelength of the coincidence frequency of the window pane.

The number, size, shape, and spacing of the cut-out section(s) 232b can be chosen and adjusted to tune the window sash 210b. The bracket 212b may also be tuned by adjusting its stiffness and/or mass by selection of the material from which it is made and/or the configuration, including thickness, of the bracket 212b.

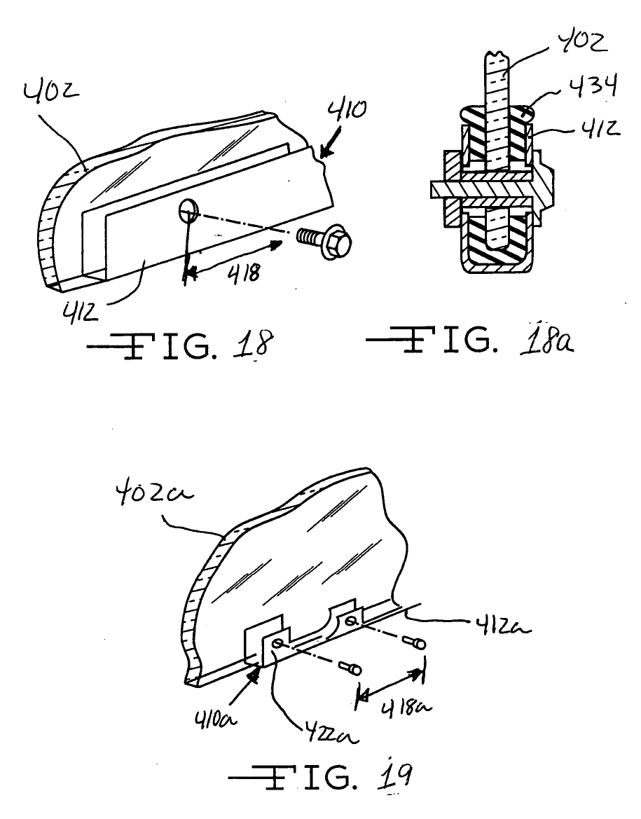

In other embodiments of the invention, as shown in FIG. 15-17, the window sash 310, 310a, 310b comprises a bracket 312, 312a, 312b that may be tuned by changing the cross-section of the bracket 312, 312a, 312b so that it is not constant along its length. As shown in FIG. 15-17, one or more ribs 340, 340a, 340b may be added to at least one sidewall 330, 330a, 330b of the bracket 312, 312a, 312b. The rib(s) 340, 340a, 340b may be of any shape, including rectangular, triangular, circular, oval, trapezoidal, ridged, and the like. The one or more ribs 340, 340a, 340b may extend substantially the length of the bracket 312, 312a, 312b, which may itself extend substantially the length of the window pane. Further, the rib(s) 340, 340a, 340b may be separated by spaced intervals 318, 318a, 318b.

The spaced intervals 318, 318a, 318b may be chosen to tune the window sash 310, 310a, 310b. Each of the spaced intervals 318, 318a, 318b may be equal in length. The spaced intervals 318, 318a, 318b may be equal to a multiple of the wavelength of the frequency of noise through the window pane targeted for reduction and may be equal to the wavelength of the coincidence frequency of the window pane.

The bracket 312, 312a, 312b may be manufactured such that the ribs 340, 340a, 340b are included in an initial manufacturing process, such as a molding process, or may be added or removed in a subsequent process, such as a stamping, crimping or rolling operation. The bracket 312, 312a, 312b may also be tuned by adjusting its stiffness and/or mass by selection of the material from which it is made and/or its thickness.

In other embodiments of the invention, as shown in FIG. 18 and FIG. 19, the window sash 410, 410a may be tuned by the manner in which the bracket 412, 412a is coupled to the window pane 402, 402a. As shown in FIG. 18, the bracket 410, 410a may be coupled to the window pane 402, 402a at spaced intervals 418, 418a. The spaced intervals 418, 418a may be chosen to tune the window sash 410, 410a. Each of the spaced intervals 418, 418a may be equal in length. The spaced intervals 418, 418a may be equal to a multiple of the wavelength of the frequency of noise through the window pane 402, 402a targeted for reduction and may be equal to the wavelength of the coincidence frequency of the window pane.

The bracket 412, 412a may be coupled to the window pane 402, 402a by ultrasonic welds, rivets, bolts, screws, clips, adhesives or any suitable manner for coupling similar or dissimilar materials. In addition, if bolts and the like are employed, the window sash 410, 410a may be further tuned by how tightly the bracket 412, 412a is coupled to the window pane 402, 402a.

In addition, as shown in FIG. 18a, a sleeve 434 may be disposed between the bracket 412 and the window pane 402. The use of a sleeve 434 and the selection of material for such sleeve 434 may also be used to tune the window sash 410.

The bracket 412, 412a may have a constant cross-section as shown in FIG. 18 or it may have flanges 422a as shown in FIG. 19. One or more brackets 412, 412a may be disposed along the length of the window pane 402, 402a, and the one or more brackets 412, 412a may be disposed substantially along the entire length of the window pane 402, 402a. The bracket 412, 412a can be tuned by adjusting its stiffness and/or mass by choosing a material of a particular rigidity or a particular configuration of the bracket 412, 412a.

### EXAMPLE 1

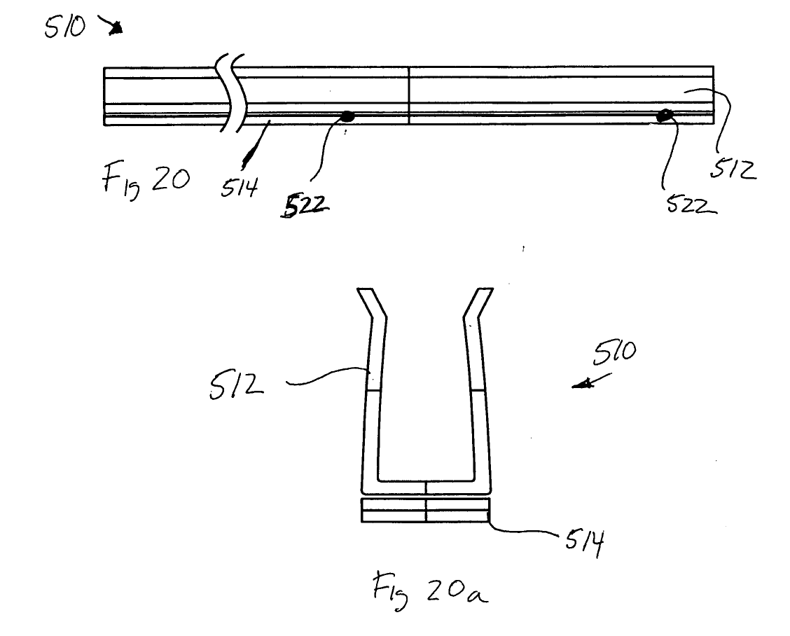

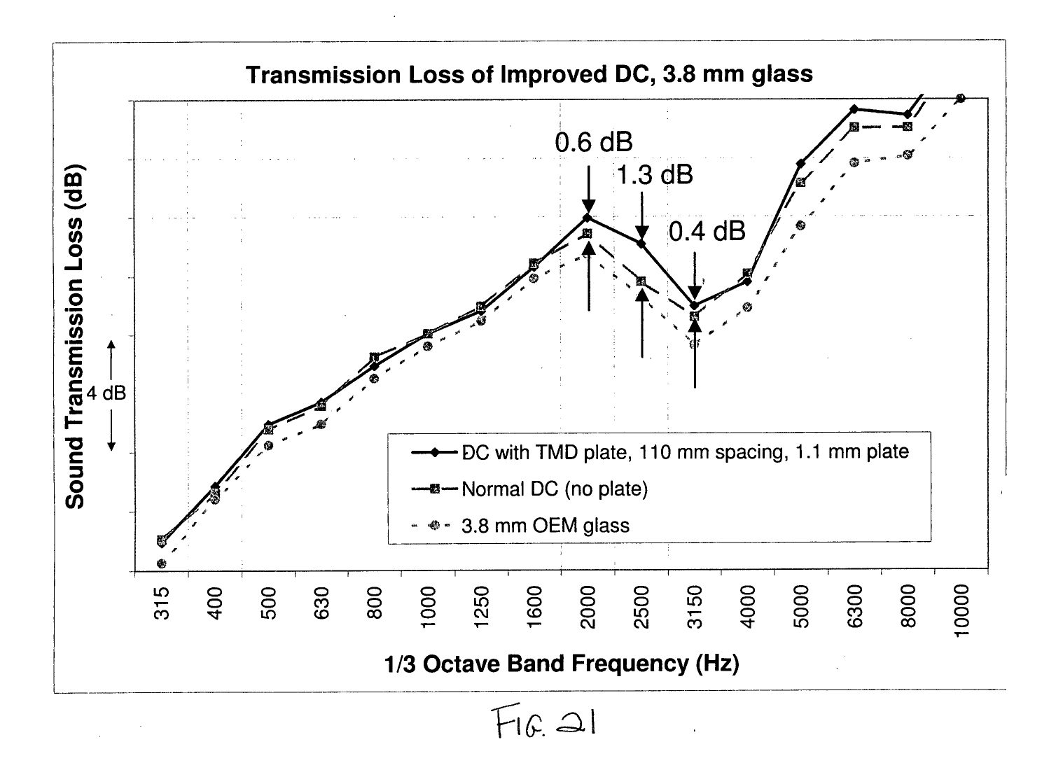

A window sash 510 of the present invention, as shown in FIG. 20, comprises a stiffener 514 with a single rectangular bar stiffener 514 coupled by tack welds to the bottom of bracket 512 at attachment points 522, located at the outer edge of the bottom of the bracket 512 and the stiffener 514. The bracket 512 and stiffener 514 are both made of mild steel. The bracket 512 is formed by a rolling process, while the stiffener 514 is formed by slitting and cutting steel sheet. The bracket 512 has an interior width of 5.4 mm, which is sufficient to hold a 3.8 mm thick pane of glass and also a rubber sleeve between the bracket 512 and the glass. The stiffener 514 is 1.1 mm thick and 8.6 mm wide, which provides the optimum stiffness and mass for the bracket 512. The attachment points 522 are spaced at 110 mm intervals, which is equal to the wavelength of sound in the glass pane at the frequency of coincidence for 3.8 mm glass.

### EXAMPLE 2

The window sash of Example with a window pane is installed in a 2003 Infiniti G35 right front car door as a test fixture. The window sash includes 3.8 mm thick window pane. Attached to the bracket is a 1.1 mm thick stiffener with interval spacing of 110-115 mm. The noise transmission is tested according to SAE standard J1400. The noise source is pink noise, approximately 105 dB level. The transmitted sound is measured by an intensity probe that scans a grid of points over the surface of the glass window pane.

FIG. 21 shows the comparative sound transmission of the window pane in window sash 510 (“DC with TMD plate”, i.e., damping channel with tuned mass damper), a window pane in a prior art damping channel (“Normal DC”, i.e., normal damping channel); and 3.8 mm glass window pane with no damping channel at all (“3.8 mm OEM glass”). The window sash is tuned to dampen noise particularly in the 3150 Hz frequency band, which are frequencies most sensitive to the human ear. Compared to the prior art damping channel, the window sash of the present invention lessens the noise by 0.6 dB in the 2000 Hz band, 1.3 dB in the 2500 Hz band, and 0.4 dB in the 3150 Hz band.

Features of various embodiments described herein may be combined so as to tune a window sash as required by a particular application. Having shown and described various embodiments, further adaptations of the methods and systems described herein can be accomplished by appropriate modifications by one of ordinary skill in the art without departing from the scope of the present invention. Several of such potential modifications have been mentioned, and others will be apparent to those skilled in the art. Accordingly, the scope of the present invention should be considered in terms of the following claims and is understood not to be limited to the details of structure and operation shown and described in the specification and drawings.

1. A window assembly comprising a window pane and a window sash, the window sash further comprising a bracket, wherein the window sash can be tuned.

2. The window assembly of claim 1 wherein the window sash is tuned to a targeted frequency.

3. The window assembly of claim 2 wherein the targeted frequency is the coincidence frequency of the window pane.

4. The window assembly of claim 1 further comprising one or more stiffeners.

5. The window assembly of claim 4 wherein the one or more stiffeners are coupled to the bracket at one or more spaced intervals, each spaced interval having a length.

6. The window assembly of claim 5 wherein the length of the one or more spaced intervals is chosen to tune the window sash.

7. The window assembly of claim 6 wherein the length of each one or more spaced intervals is equal to a multiple of the wavelength of a targeted frequency.

8. The window assembly of claim 7 wherein the targeted frequency is the coincidence frequency of the window pane.

9. The window assembly of claim 4 wherein the window sash is tuned by adjusting the stiffness of one of the following: the one or more stiffeners, the bracket, and a combination of both.

10. The window assembly of claim 4 wherein the window sash is tuned by adjusting the mass of one of the following: the one or more stiffeners, the bracket, and a combination of both.

11. The window assembly of claim 6 wherein the window sash is tuned by adjusting the stiffness of one of the following: the one or more stiffeners, the bracket, and a combination of both.

12. The window assembly of claim 6 wherein the window sash is tuned by adjusting the mass of one of the following: the one or more stiffeners, the bracket, and a combination of both.

13. The window assembly of claim 6 wherein the window sash is tuned by (a) adjusting the stiffness of one of the following: the one or more stiffeners, the bracket, and a combination of both; and (b) adjusting the mass of one of the following: the one or more stiffeners, the bracket, and a combination of both.

14. The window assembly of claim 1 wherein the window sash is tuned by one or more cut-out sections.

15. The window assembly of claim 14 wherein the one or more cut-out sections are separated by one or more spaced intervals, each interval having a length.

16. The window assembly of claim 15 wherein the length of the one or more spaced intervals is chosen to tune the window sash.

17. The window assembly of claim 16 wherein the length of each one or more spaced intervals is equal to a multiple of the wavelength of a targeted frequency.

18. The window assembly of claim 17 wherein the targeted frequency is the coincidence frequency of the window pane.

19. The window assembly of claim 14 wherein the window sash is tuned by adjusting the stiffness of the bracket.

20. The window assembly of claim 14 wherein the window sash is tuned by adjusting the mass of the bracket.

21. The window assembly of claim 16 wherein the window sash is tuned by adjusting the stiffness of the bracket.

22. The window assembly of claim 16 wherein the window sash is tuned by adjusting the mass of the bracket.

23. The window assembly of claim 16 wherein the window sash is tuned by adjusting the stiffness of the bracket and by adjusting the mass of the bracket.

24. The window assembly of claim 1 wherein the bracket further comprises one or more ribs.

25. The window assembly of claim 24 wherein the one or more ribs are separated by one or more spaced intervals, each interval having a length.

26. The window assembly of claim 25 wherein the length of the one or more spaced intervals is selected to tune the window sash.

27. The window assembly of claim 26 wherein the length of each one or more spaced intervals is equal to a multiple of the wavelength of a targeted frequency.

28. The window assembly of claim 27 wherein the targeted frequency is the coincidence frequency of the window pane.

29. The window assembly of claim 24 wherein the bracket is tuned by adjusting the stiffness of the bracket.

30. The window assembly of claim 24 wherein the bracket is tuned by adjusting the mass of the bracket.

31. The window assembly of claim 26 wherein the bracket is tuned by adjusting the stiffness of the bracket.

32. The window assembly of claim 26 wherein the bracket is tuned by adjusting the mass of the bracket.

33. The window assembly of claim 26 wherein the bracket is tuned by adjusting the mass of the bracket and by adjusting the stiffness of the bracket.

34. The window assembly of claim 1 wherein the window sash is tuned by coupling the bracket to the window pane at one or more spaced intervals, each interval having a length.

35. The window assembly of claim 34 wherein the length of the one or more spaced intervals is selected to tune the window sash.

36. The window assembly of claim 35 wherein the length of each one or more spaced intervals is equal to a multiple of the wavelength of a targeted frequency.

37. The window assembly of claim 36 wherein the targeted frequency is the coincidence frequency of the window pane.

38. The window assembly of claim 34 wherein the window sash is tuned by adjusting the stiffness of the bracket.

39. The window assembly of claim 34 wherein the window sash is tuned by adjusting the mass of the bracket.

40. The window assembly of claim 38 wherein the window sash is tuned by adjusting the mass of the bracket.

41. A window sash for mounting a window pane comprising a bracket, wherein the window sash can be tuned.

42. The window sash of claim 41 wherein the window sash is tuned to a targeted frequency.

43. The window sash of claim 42 wherein the targeted frequency is the coincidence frequency of the window pane.

44. The window sash of claim 41 further comprising one or more stiffeners.

45. The window sash of claim 44 wherein the one or more stiffeners are coupled to the bracket at one or more spaced intervals, each spaced interval having a length.

46. The window sash of claim 45 wherein the length of the one or more spaced intervals is chosen to tune the window sash.

47. The window sash of claim 46 wherein the length of each one or more spaced intervals is equal to a multiple of the wavelength of a targeted frequency.

48. The window sash of claim 47 wherein the targeted frequency is the coincidence frequency of the window pane.

49. The window sash of claim 44 wherein the window sash is tuned by adjusting the stiffness of one of the following: the one or more stiffeners, the bracket, and a combination of both.

50. The window sash of claim 44 wherein the window sash is tuned by adjusting the mass of one of the following: the one or more stiffeners, the bracket, and a combination of both.

51. The window sash of claim 46 wherein the window sash is tuned by adjusting the stiffness of one of the following: the one or more stiffeners, the bracket, and a combination of both.

52. The window sash of claim 46 wherein the window sash is tuned by adjusting the mass of one of the following: the one or more stiffeners, the bracket, and a combination of both.

53. The window sash of claim 46 wherein the window sash is tuned by (a) adjusting the stiffness of one of the following: the one or more stiffeners, the bracket, and a combination of both; and (b) adjusting the mass of one of the following: the one or more stiffeners, the bracket, and a combination of both.

54. The window sash of claim 44 wherein the one or more stiffeners comprise one or more bars.

55. The window sash of claim 54 wherein the one or more bars are substantially hollow.

56. The window sash of claim 41 wherein the window sash comprises one or more cut-out sections.

57. The window sash of claim 56 wherein the one or more cut-out sections are separated by one or more spaced intervals, each interval having a length.

58. The window sash of claim 57 wherein the length of the one or more spaced intervals is chosen to tune the window sash.

59. The window sash of claim 58 wherein the length of each one or more spaced intervals is equal to a multiple of the wavelength of a targeted frequency.

60. The window sash of claim 59 wherein the targeted frequency is the coincidence frequency of the window pane.

61. The window sash of claim 56 wherein the window sash is tuned by adjusting the stiffness of the bracket.

62. The window sash of claim 56 wherein the window sash is tuned by adjusting the mass of the bracket.

63. The window sash of claim 58 wherein the window sash is tuned by adjusting the stiffness of the bracket.

64. The window sash of claim 58 wherein the window sash is tuned by adjusting the mass of the bracket.

65. The window sash of claim 58 wherein the window sash is tuned by adjusting the mass of the bracket and the stiffness of the bracket.

66. The window sash of claim 41 wherein the bracket further comprises one or more ribs.

67. The window sash of claim 66 wherein the one or more ribs are separated by one or more spaced intervals, each interval having a length.

68. The window sash of claim 67 wherein the length of the one or more spaced intervals is selected to tune the window sash.

69. The window sash of claim 68 wherein the length of each one or more spaced intervals is equal to a multiple of the wavelength of a targeted frequency.

70. The window sash of claim 69 wherein the targeted frequency is the coincidence frequency of the window pane.

71. The window sash of claim 66 wherein the bracket is tuned by adjusting the stiffness of the bracket.

72. The window sash of claim 66 wherein the bracket is tuned by adjusting the mass of the bracket.

73. The window sash of claim 68 wherein the bracket is tuned by adjusting the stiffness of the bracket.

74. The window sash of claim 68 wherein the bracket is tuned by adjusting the mass of the bracket.

75. The window sash of claim 68 wherein the bracket is tuned by adjusting the stiffness of the bracket and by adjusting the mass of the bracket.

76. The window sash of claim 41 wherein the window sash is tuned by coupling the bracket to the window pane at one or more spaced intervals, each interval having a length.

77. The window sash of claim 76 wherein the length of the one or more spaced intervals is selected to tune the window sash.

78. The window sash of claim 77 wherein the length of each one or more spaced intervals is equal to a multiple of the wavelength of a targeted frequency.

79. The window sash of claim 78 wherein the targeted frequency is the coincidence frequency of the window pane.

80. The window sash of claim 76 wherein the window sash is tuned by adjusting the stiffness of the bracket.

81. The window sash of claim 76 wherein the window sash is tuned by adjusting the mass of the bracket.

82. The window sash of claim 76 wherein the window sash is tuned by adjusting the stiffness of the bracket and adjusting the mass of the bracket.

83. A method of tuning a window sash comprising the steps of
providing a tunable window sash comprising a bracket with interval spacing;
tuning said window sash.

84. The method of claim 83 wherein said tuning step comprises the step of selecting the interval spacing to tune the window sash.

85. The method of claim 83 wherein said tuning step comprises the step of adjusting the stiffness of the bracket.

86. The method of claim 83 wherein said tuning step comprises the step of adjusting the mass of the bracket.

87. The method of claim 84 wherein said tuning step comprises the step of adjusting the stiffness of the bracket.

88. The method of claim 84 wherein said tuning step comprises the step of adjusting the mass of the bracket.

89. The method of claim 84 wherein said tuning step comprises the steps of adjusting stiffness of the bracket and adjusting the mass of the bracket.

90. The method of claim 83 wherein the bracket further comprises one or more stiffeners coupled to said bracket.

91. The method of claim 90 wherein said tuning step comprises the step of adjusting the stiffness of one of the following: the one or more stiffeners, the bracket, and a combination of both.

92. The method of claim 90 wherein said tuning step comprises the step of adjusting the mass of one of the following: the one or more stiffeners, the bracket, and a combination of both.

93. The method of claim 90 further comprising the step of selecting the interval spacing to tune the window sash.

94. The method of claim 93 wherein said tuning step comprises the step of adjusting the stiffness of one of the following: the one or more stiffeners, the bracket, and a combination of both.

95. The method of claim 93 wherein said tuning step comprises the step of adjusting the mass of one of the following: the one or more stiffeners, the bracket, and a combination of both.

96. The method of claim 93 wherein said tuning step comprises the step of (a) adjusting the stiffness of one of the following: the one or more stiffeners, the bracket, and a combination of both; and (b) adjusting the mass of one of the following: the one or more stiffeners, the bracket, and a combination of both.
